(19) United States
(12) Patent Application Publication
(10) Pub. No.: US 2013/0162081 A1
(43) Pub. Date: Jun. 27, 2013

(54) HYDRODYNAMIC BEARING ASSEMBLY AND MOTOR INCLUDING THE SAME

(71) Applicant: Bum Cho Kim, Seoul (KR)

(72) Inventor: Bum Cho Kim, Seoul (KR)

(73) Assignee: SAMSUNG ELECTRO-MECHANICS CO., LTD., Suwon (KR)

(21) Appl. No.: 13/545,293

(22) Filed: Jul. 10, 2012

(30) Foreign Application Priority Data
Dec. 26, 2011 (KR) 10-2011-0142690

(51) Int. Cl. H02K 5/16

(52) U.S. Cl. 310/90

(57) ABSTRACT

There are provided a hydrodynamic bearing assembly and a motor including the same. The hydrodynamic bearing assembly includes: a fixed member; a rotating member forming, together with the fixed member, a bearing clearance filled with a lubricating fluid and rotating relatively with respect to the fixed member; upper and lower radial dynamic pressure grooves formed in at least one of the fixed member and the rotating member forming the bearing clearance therebetween while facing each other in order to generate hydrodynamic pressure at the time of rotation of the rotating member; and an auxiliary groove formed in at least one of the fixed member and the rotating member between the upper and lower radial dynamic pressure grooves in order to pump the lubricating fluid upwardly or downwardly.

### CROSS-REFERENCE TO RELATED APPLICATIONS

This application claims the priority of Korean Patent Application No. 10-2011-0142690 filed on Dec. 26, 2011, in the Korean Intellectual Property Office, the disclosure of which is incorporated herein by reference.

### BACKGROUND OF THE INVENTION

1. Field of the Invention

The present invention relates to a hydrodynamic bearing assembly and a motor including the same.

2. Description of the Related Art

A hard disk drive (HDD), an information storage device, reads data stored on a disk or writes data to a disk using a read/write head.

A hard disk drive requires a disk driving device capable of driving the disk therein. As the disk driving device, a small-sized motor is commonly used.

The small-sized motor has utilized a hydrodynamic bearing assembly. A rotating member and a fixed member of the hydrodynamic bearing assembly are spaced apart from each other by a predetermined interval to thereby form a bearing clearance, and oil is disposed in the bearing clearance, such that the rotating member is supported by fluid pressure generated in the oil.

Meanwhile, upper and lower radial dynamic pressure grooves for generating hydrodynamic pressure at the time of the rotation of the rotating member are formed in at least one of the fixed member and the rotating member in a portion in which the fixed member and the rotating member form a bearing clearance while facing each other.

In this case, in the upper and lower radial dynamic pressure grooves, a general direction in which a lubricating fluid is pumped should be determined. Therefore, since either of the upper and lower radial dynamic pressure grooves should have an axial length greater than that of the other radial dynamic pressure groove, a sufficient bearing span may not be secured, which may affect the rigidity of a spindle motor bearing, such that performance of the spindle motor may be deteriorated.

### RELATED ART DOCUMENT

(Patent Document 1) Japanese Patent Laid-Open Publication No. 2007-107622

### SUMMARY OF THE INVENTION

An aspect of the present invention provides a hydrodynamic bearing assembly in which a unit capable of pumping a fluid unidirectionally is additionally provided between upper and lower radial dynamic pressure grooves to supplement the roles thereof, such that a bearing span increase is realized, thereby improving rotational rigidity in a motor, and a motor including the same.

According to an aspect of the present invention, there is provided a hydrodynamic bearing assembly including: a fixed member; a rotating member forming, together with the fixed member, a bearing clearance filled with a lubricating fluid and rotating relatively with respect to the fixed member; upper and lower radial dynamic pressure grooves formed in at least one of the fixed member and the rotating member forming the bearing clearance therebetween while facing each other in order to generate hydrodynamic pressure at the time of rotation of the rotating member; and an auxiliary groove formed in at least one of the fixed member and the rotating member between the upper and lower radial dynamic pressure grooves in order to pump the lubricating fluid upwardly or downwardly.

The auxiliary groove may have a spiral shape or a helical shape.

The auxiliary groove may be provided to pump the lubricating fluid in a direction of resultant hydrodynamic pressure force generated by the upper and lower radial dynamic pressure grooves through the rotation of the rotating member.

The upper and lower radial dynamic pressure grooves may include a groove shaped reservoir part formed in at least one of the fixed member and the rotating member so that the bearing clearance between the fixed member and the rotating member is wider in the reservoir part as compared to other portions thereof, and the auxiliary groove may be formed in the reservoir part.

The upper and lower radial dynamic pressure grooves may include a groove shaped reservoir part formed in at least one of the fixed member and the rotating member so that the bearing clearance between the fixed member and the rotating member is wider in the reservoir part as compared to other portions thereof, and the auxiliary groove may be formed in a counterpart member facing the reservoir part.

The auxiliary groove may be formed in a portion of the fixed member and the rotating member forming the bearing clearance therebetween in which fluid pressure is relatively low.

The auxiliary groove may be formed in a circumferential direction.

According to another aspect of the present invention, there is provided a hydrodynamic bearing assembly including: a shaft; a sleeve having the shaft rotatably inserted thereinto and forming, together with the shaft, a bearing clearance filled with a lubricating fluid; upper and lower radial dynamic pressure grooves formed in at least one of the sleeve and the shaft forming the bearing clearance therebetween while facing each other in order to generate hydrodynamic pressure at the time of rotational driving of the shaft; and an auxiliary groove formed in at least one of the sleeve and the shaft between the upper and lower radial dynamic pressure grooves in order to pump the lubricating fluid upwardly or downwardly.

According to another aspect of the present invention, there is provided a hydrodynamic bearing assembly including: a shaft fixedly installed directly or indirectly on a base member; a sleeve rotatably installed on the shaft and forming, together with the shaft, a bearing clearance filled with a lubricating fluid; upper and lower radial dynamic pressure grooves formed in at least one of the sleeve and the shaft forming the bearing clearance therebetween while facing each other in order to generate hydrodynamic pressure at the time of rotational driving of the sleeve; and an auxiliary groove formed in at least one of the sleeve and the shaft between the upper and lower radial dynamic pressure grooves in order to pump the lubricating fluid upwardly or downwardly.

According to another aspect of the present invention, there is provided a spindle motor including: a hydrodynamic bearing assembly including a fixed member, a rotating member forming, together with the fixed member, a bearing clearance filled with a lubricating fluid and rotating relatively with respect to the fixed member, upper and lower radial dynamic pressure grooves formed in at least one of the fixed member and the rotating member forming the bearing clearance therebetween while facing each other in order to generate hydrodynamic pressure at the time of rotation of the rotating member, and an auxiliary groove formed in at least one of the fixed member and the rotating member between the upper and lower radial dynamic pressure grooves in order to pump the lubricating fluid upwardly or downwardly; a stator coupled to the fixed member outwardly of the fixed member or the rotating member and including a core having a coil wound therearound in order to generate rotational driving force; and a hub fixed to the rotating member so as to be rotatable with respect to the stator and having a magnet mounted on one surface thereof, the magnet facing the coil.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a motor according to an embodiment of the present invention;

FIG. 2 is a cross-sectional perspective view of a sleeve of a motor according to an embodiment of the present invention;

FIG. 3 is a schematic cross-sectional view showing a motor according to another embodiment of the present invention;

FIG. 4 is a perspective view of a shaft of a motor according to another embodiment of the present invention; and

FIGS. 5A and 5B are schematic cross-sectional views of a disk driving device using a motor according to an embodiment of the present invention.

### DETAILED DESCRIPTION OF THE EMBODIMENTS

Embodiments of the present invention will now be described in detail with reference to the accompanying drawings. However, it should be noted that the spirit of the present invention is not limited to the embodiments set forth herein and those skilled in the art and understanding the present invention could easily accomplish retrogressive inventions or other embodiments included in the spirit of the present invention by the addition, modification, and removal of components therein, but those are to be construed as being included in the spirit of the present invention.

Further, when it is determined that a detailed description of the known art, related to the present invention, may obscure the gist of the present invention, a detailed description thereof will be omitted.

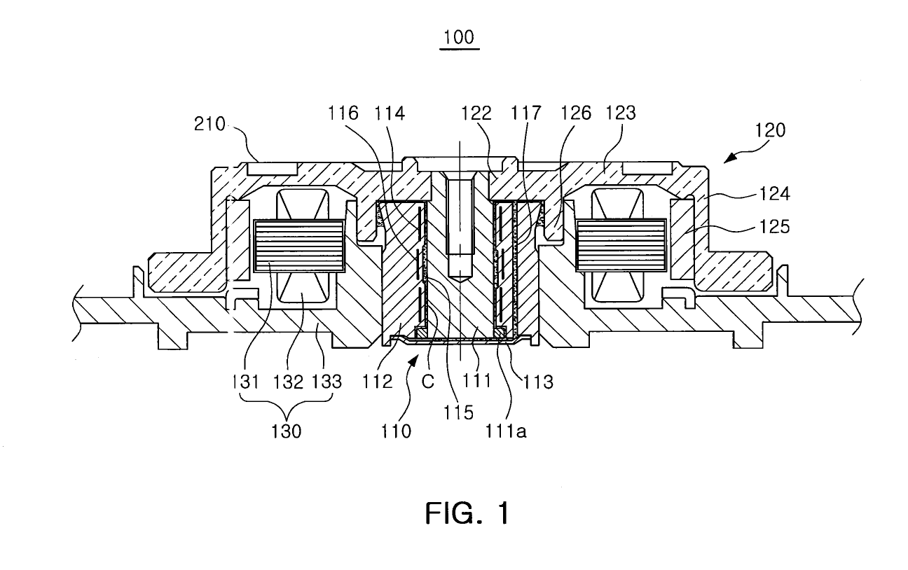

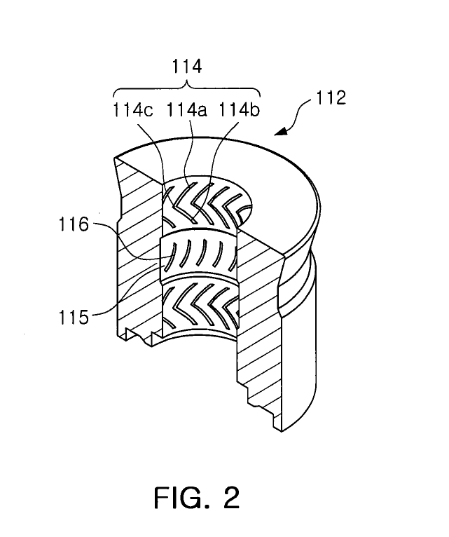

FIG. 1 is a schematic cross-sectional view showing a motor according to an embodiment of the present invention; and FIG. 2 is a cross-sectional perspective view showing a sleeve of the motor according to the embodiment of the present invention.

Referring to FIGS. 1 and 2, a motor 100 according to an embodiment of the present invention may include a hydrodynamic bearing assembly 110 including a shaft 111 and a sleeve 112, a rotor 120 including a hub 121, and a stator 130 including a core 131 having a coil 132 wound therearound.

The hydrodynamic bearing assembly 110 may include the shaft 111, the sleeve 112, a stopper 111a, and the hub 121, and the hub 121 may form the hydrodynamic bearing assembly 110 while simultaneously forming the rotor 120 to be described below.

Terms with respect to directions will be first defined. As viewed in FIG. 1, an axial direction refers to a vertical direction based on the shaft 111, and an outer or inner radial direction refers to a direction toward an outer edge of the hub 121 based on the shaft 111 or a direction toward the center of the shaft 111 based on the outer edge of the hub 121.

Further, in the following description, a rotating member may include the shaft 111, the rotor 120 including the hub 121, a magnet 125 mounted on the rotor 120, and the like, and a fixed member, referring to a member except for the rotating member, may be relatively fixed to the rotating member and include the sleeve 112, the stator 130, a base, and the like.

In addition, a communication path with the outside in an oil interface refers to a path connected to the outside of the motor and may allow for air input and output therethrough.

The sleeve 112 may support the shaft 111 such that an upper end of the shaft 111 is protruded upwardly in the axial direction. The sleeve 112 may be formed by sintering a Cu—Fe-based alloy powder or a SUS-based powder. However, the sleeve is not limited to being manufactured by the above-mentioned method, but may be manufactured by various methods.

In this configuration, the shaft 111 may be inserted into a shaft hole of the sleeve 112 with a micro clearance therebetween to thereby serve as a bearing clearance C. This bearing clearance C may be filled with oil, and rotation of the rotor 120 may be more smoothly supported by upper and lower radial dynamic pressure grooves 114 formed in at least one of an outer diameter of the shaft 111 and an inner diameter of the sleeve 120.

The radial dynamic pressure grooves 114 may be formed in an inner surface of the sleeve 112, which is an inner portion of the shaft hole of the sleeve 112, and generate pressure so that the shaft 111 may smoothly rotate in a state in which the shaft 111 is spaced apart from the sleeve 112 by a predetermined interval at the time of rotation thereof.

However, the radial dynamic pressure groove 114 is not limited to being formed in the inner surface of the sleeve 112 as described above but may also be formed in an outer diameter portion of the shaft 111. In addition, the number of radial dynamic pressure grooves 114 is not limited.

Here, the radial dynamic pressure groove 114 may have at least one of a herringbone shape, a spiral shape, and a helical shape. However, the radial dynamic pressure groove 114 may have any shape as long as it may generate radial dynamic pressure.

The sleeve 112 may include a circulation hole 117 formed therein so as to allow upper and lower portions thereof to communicate with each other to thereby disperse pressure of the oil in an inner portion of the hydrodynamic bearing assembly 110 and maintain pressure balance, and move air bubbles, or the like, present in the inner portion of the hydrodynamic bearing assembly 110 to be discharged by circulation.

Here, a lower end of the sleeve 112 may be provided with the stopper 111a protruding from a lower end portion of the shaft 111 in the outer radial direction. This stopper 111a may be caught by a lower end surface of the sleeve 112 to limit floating of the shaft 111 and the rotor 120.

Meanwhile, according to the embodiment of the present invention, at least one auxiliary groove 116 may be formed in an inner peripheral surface of the sleeve 112 corresponding to the fixed member and an outer peripheral surface of the shaft 111 corresponding to the rotating member. The auxiliary groove 116 may be formed between the upper and lower radial dynamic pressure grooves 114. However, the auxiliary groove 116 may be additionally formed in a member that has the radial dynamic pressure grooves 114 or be formed in a member that does not have the radial pressure dynamic pressure grooves 114. Here, the auxiliary groove 116 may have a spiral shape or a helical shape. Although FIGS. 1 and 2 show that the auxiliary groove 116 is only formed on the sleeve 112, the present invention is not limited thereto.

In addition, the auxiliary groove 116 may be formed so as to pump the fluid in a direction of resultant hydrodynamic pressure force generated by the upper and lower radial dynamic pressure grooves 114 by the rotation of the shaft 111.

As shown in FIG. 2, the spindle motor uses a fluid bearing. In general, the spindle motor may include a pair of upper and lower radial dynamic pressure grooves for stability of rotation to thereby form two fluid bearings. However, in the case of the motor using the hydrodynamic bearing, since the rotating member needs to rotate in a state in which it is floated at a predetermined height without contacting a bottom plate (a base cover 113 in the present embodiment), the fluid needs to be continuously pumped downwardly in the axial direction.

Therefore, in the upper radial dynamic pressure groove of the herringbone shaped radial dynamic pressure grooves 114 shown in FIG. 2, an upper wing 114a (a wing disposed in an upper portion in the axial direction among diagonally formed wings) is required to have the greater pumping force. In order to allow the upper wing 114a to have the greater pumping force, the upper wing 114a is formed to be longer. Due to this fact, since a bearing center 114c corresponding to a point at which upper and lower wings 114a and 114b meet in the upper radial dynamic pressure groove 114 will move downwardly in the axial direction, a bearing span (a distance between the bearing centers of the upper and lower radial dynamic pressure grooves) may be slightly shortened.

However, when the auxiliary groove 116 is additionally formed between the upper and lower radial dynamic pressure grooves to supplement the pumping of the fluid, even in the case in which a length of the upper wing of the upper radial dynamic pressure groove is slightly shortened, a problem may not occur in implementing the performance of the motor, so that the bearing span may be lengthened. In this case, since rigidity of the bearing of the motor is increased, the rotating member stably rotates, whereby the performance of the motor may be improved.

Meanwhile, a groove shaped reservoir part 115 may be formed in at least one of the sleeve 112 and the shaft 111 between the upper and lower radial dynamic pressure grooves 114 such that the bearing clearance between the sleeve 112 and the shaft 111 is wider in the reservoir part 115 as compared to other portions thereof. In this case, the auxiliary groove 116 may be formed in the reservoir part 115 or a counter member facing the reservoir part 115. Although FIGS. 1 and 2 show that the reservoir part 115 is formed in the inner peripheral surface of the sleeve 112 in the circumferential direction, the present invention is not limited thereto. That is, the reservoir part 115 may be formed in the outer peripheral surface of the shaft 111 in the circumferential direction.

In addition, the auxiliary groove 116 may be formed in a portion of the sleeve or the shaft forming the bearing clearance therebetween in which fluid pressure is relatively low, for example, in the reservoir part 115. Since the auxiliary groove 116 may serve to assist in pumping the fluid, it is not preferable that the pumping force is excessively increased. Therefore, fluid pressure may be formed to be relatively low to thereby allow the pumping force not to be increased to a predetermined level or more.

Meanwhile, the sleeve 112 may include a base cover 113 coupled to a lower portion thereof in the axial direction while having a clearance therebetween, and the clearance receives the oil therein.

The base cover 113 may receive the oil in the clearance between the base cover 230 and the sleeve 112 to thereby serve as a bearing supporting a lower surface of the shaft 111.

The hub 121, which is a rotating member coupled to the shaft 111 and rotating together with the shaft 111, may form the rotor 120 while simultaneously forming the hydrodynamic bearing assembly 110. Hereinafter, the rotor 120 will be described in detail.

The rotor 120 is a rotating structure provided to be rotatable with respect to the stator 130 and may include the hub 121 having an annular ring-shaped magnet 125 provided on an outer peripheral surface thereof, and the annular ring-shaped magnet 125 corresponds to a core 131, while having a predetermined interval therebetween.

In other words, the hub 121 may be a rotating member coupled to the shaft 111 to thereby rotate together with the shaft 111.

Here, as the magnet 125, a permanent magnet generating magnetic force having predetermined strength by alternately magnetizing an N pole and an S pole thereof in the circumferential direction may be used.

In addition, the hub 121 may include a first cylindrical wall part 122 fixed to an upper end of the shaft 111, a disk part 123 extended from an end portion of the first cylindrical wall part 122 in the outer radial direction, and a second cylindrical wall part 124 protruded downwardly from an outer radial end portion of the disk part 123, and the magnet 125 may be coupled to an inner peripheral surface of the second cylindrical wall part 124.

The hub 121 may have a main wall part 126 extended downwardly in the axial direction so as to correspond to an upper outer portion of the sleeve 112.

In addition, an inner peripheral surface of the main wall part 126 may be tapered, such that an interval between the inner peripheral surface of main wall part 116 and the outer surface of the sleeve 112 is increased in the downward axial direction to thereby facilitate the sealing of the oil. Further, the outer peripheral surface of the sleeve 112 may also be tapered to thereby facilitate the sealing of the oil.

The stator 130 may include the coil 132, the core 131, and a base member 133.

In other words, the stator 130, a fixed structure, includes the coil 132 generating electromagnetic force having a predetermined magnitude at the time of application of power and the plurality of cores 131 having the coil 132 wound therearound.

The core 131 may be fixedly disposed above an upper portion of the base member 133 including a printed circuit board (not shown) having a circuit pattern printed thereon. A plurality of coil holes having a predetermined size may be formed in the upper surface of the base member 133 corresponding to the winding coil 132 to penetrate through the base member 133 such that the winding coil 132 is exposed therethrough downwardly. The winding coil 132 may be electrically connected to the printed circuit board (not shown) such that external power is supplied thereto.

The base member 133 may be fixed to the outer peripheral surface of the sleeve 112 and include the core 131 having the coil 132 wound therearound inserted thereinto. In addition, the base member 133 and the sleeve 112 may be assembled to each other by applying an adhesive to an inner surface of the base member 133 or an outer surface of the sleeve 112.

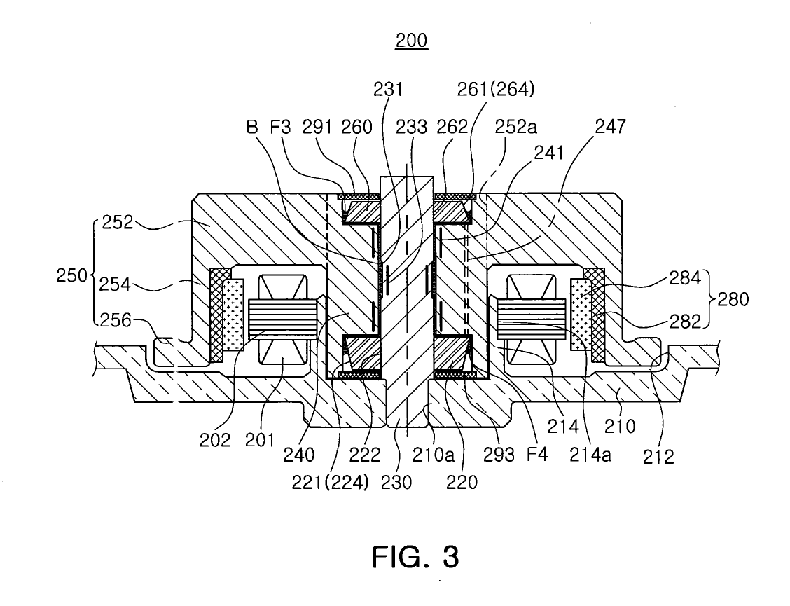

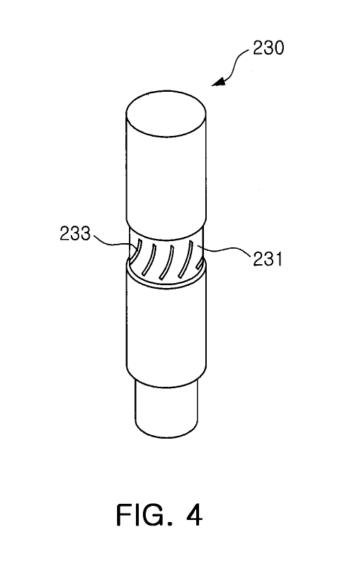

FIG. 3 is a schematic cross-sectional view showing a motor according to another embodiment of the present invention; and FIG. 4 is a perspective view showing a shaft of the motor according to another embodiment of the present invention.

Referring to FIGS. 3 and 4, the spindle motor 200 according to another embodiment of the present invention may include a base member 210, a lower thrust member 220, a shaft 230, a sleeve 240, a rotor hub 250, and an upper thrust member 260.

Here, a hydrodynamic bearing assembly may include the shaft 230, the sleeve 240, the upper and lower thrust members 220 and 260, and the rotor hub 250.

Here, terms with respect to directions will be defined. As viewed in FIG. 3, an axial direction refers to a vertical direction, that is, a direction from a lower portion of the shaft 230 toward an upper portion thereof or a direction from the upper portion of the shaft 230 toward the lower portion thereof; a radial direction refers to a horizontal direction, that is, a direction from the shaft 230 toward an outer peripheral surface of the rotor hub 250 or from the outer peripheral surface of the rotor hub 250 toward the shaft 230; and a circumferential direction refers to a rotation direction along a circumference of a circle having a predetermined radius from the center of rotation.

Further, in the following description, a rotating member may include the sleeve 240, the rotor hub 250, a magnet 280 mounted on the rotor hub 250, and the like, and a fixed member, which is a member except for the rotating member, may be relatively fixed to the rotating member and include the shaft 230, the upper and lower thrust members 220 and 260, the base member 210, and the like.

The base member 210 may include a mounting groove 212 so as to form a predetermined space with the rotor hub 250. In addition, the base member 210 may include a coupling part 214 extended upwardly in the axial direction and having a stator core 202 installed on an outer peripheral surface thereof.

In addition, the coupling part 214 may include a seat surface 214a provided on the outer peripheral surface thereof such that the stator core 202 may be seated thereon. Further, the stator core 202 seated on the coupling part 214 may be disposed over the mounting groove 212 of the base member 210.

The shaft 230 may be fixedly installed on the base member 210. That is, a lower end portion of the shaft 230 may be inserted into an installation hole 210a formed in the base member 210. In addition, the lower end portion of the shaft 230 may be bonded to an inner surface of the base member 210 by an adhesive and/or welding, so that the shaft 230 may be fixed thereto.

Meanwhile, the shaft 230 may form, together with upper and lower thrust members 260 and 220 and the base member 210, the fixed member, that is, the stator.

The shaft 230 may include a coupling unit, such as a screw part having a screw coupled thereto, formed on an upper surface thereof so that a cover member (not shown) is fixedly installed thereto.

The sleeve 240 may be rotatably installed on the shaft 230. To this end, the sleeve 240 may include a shaft support part provided as a through hole into which the shaft 230 is inserted. Meanwhile, in the case in which the sleeve 240 is installed on the shaft 230, the inner peripheral surface of the sleeve 240 and the outer peripheral surface of the shaft 230 may be spaced apart from each other by a predetermined interval to thereby form a bearing clearance B therebetween. In addition, the bearing clearance B may be filled with a lubricating fluid.

Further, the sleeve 240 may include upper and lower groove parts in which the upper and lower thrust members 260 and 220 are received. The upper and lower groove parts may be formed by groove part bottoms and groove part sidewalls, respectively. In the present embodiment, ‘groove part bottom’ refers to a surface of each of the groove parts disposed perpendicular with regard to the axial direction, and ‘groove part sidewall’ refers to a surface of each of the groove parts disposed in parallel with regard to the axial direction.

In addition, radial dynamic pressure grooves 241 may be formed in an inner surface of the sleeve 240 in order to generate hydrodynamic pressure via the lubricating fluid filling the bearing clearance B at the time of rotation thereof. That is, the upper and lower radial dynamic pressure grooves 241 may be formed as shown in FIG. 3.

However, the radial dynamic pressure groove is not limited to being formed in the inner surface of the sleeve 240, but may also be formed in the outer peripheral surface of the shaft 230 and have various shapes such as a herringbone shape, a spiral shape, a helical shape, or the like.

In addition, the sleeve 240 may include a circulation hole 247 formed therein in order to allow upper and lower groove parts of the sleeve 240 to communicate with each other. The circulation hole 247 may discharge air bubbles contained in the lubricating fluid filling the bearing clearance B and facilitate circulation of the lubricating fluid.

Meanwhile, according to another embodiment of the present invention, at least one auxiliary groove 233 may be formed in the outer peripheral surface of the shaft 230 corresponding to the fixed member or the outer peripheral surface of the sleeve 240 corresponding to the rotating member. The auxiliary groove 233 may be formed between the upper and lower radial dynamic pressure grooves 241. However, the auxiliary groove 233 may be additionally formed in a member that includes the radial dynamic pressure grooves 241 or be formed in a member that does not include the radial pressure dynamic pressure grooves 241. Here, the auxiliary groove 233 may have a spiral shape or a helical shape. Although FIGS. 3 and 4 shows that the auxiliary groove 233 is only formed in the shaft 230, the present invention is not limited thereto.

In addition, the auxiliary groove 233 may be formed so as to pump the fluid in a direction of resultant hydrodynamic pressure force generated by the upper and lower radial dynamic pressure grooves 241 by the rotation of the sleeve 240.

The spindle motor uses a fluid bearing. In general, the spindle motor may include a pair of upper and lower radial dynamic pressure grooves for stability of rotation to thereby form two fluid bearings. However, in the case of the motor using the hydrodynamic bearing, since the rotating member needs to rotate in a state in which it is floated at a predetermined height without contacting a bottom plate (a base member 210 in the present embodiment), the fluid needs to be continuously pumped downwardly in the axial direction.

Therefore, in the case of the herringbone shaped radial dynamic pressure grooves 240, an upper wing (a wing disposed in an upper portion in the axial direction among diagonally formed wings) in the upper radial dynamic pressure groove is required to have the greater pumping force. In order to allow the upper wing to have the greater pumping force, the upper wing is formed to be longer. Due to this fact, since a bearing center corresponding to a point at which upper and lower wings meet in the upper radial dynamic pressure groove will move downwardly in the axial direction, a bearing span (a distance between the bearing centers of the upper and lower radial dynamic pressure grooves) may be slightly shortened.

However, when the auxiliary groove 233 is additionally formed between the upper and lower radial dynamic pressure grooves to supplement the pumping of the fluid, even in the case in which a length of the upper wing of the upper radial dynamic pressure groove is slightly shortened, a problem may not occur in the performance of the motor, so that the bearing span may be lengthened. In this case, since rigidity of the bearing of the motor is increased, the rotating member stably rotates, whereby the performance of the motor may be improved.

Meanwhile, a groove shaped reservoir part 231 may be formed in at least one of the sleeve 240 and the shaft 230 between the upper and lower radial dynamic pressure grooves 241 such that the bearing clearance between the sleeve 240 and the shaft 230 is wider in the reservoir part 231 as compared to portions thereof. In this case, the auxiliary groove 233 may be formed in the reservoir part 231 or a counter member facing the reservoir part 231. Although FIGS. 3 and 4 show that the reservoir part 231 is provided in the outer peripheral surface of the shaft 230 in the circumferential direction, the present invention is not limited thereto. That is, the reservoir part 231 may be provided on the inner peripheral surface of the sleeve 240 in the circumferential direction.

In addition, the auxiliary groove 233 may be formed in a portion of the sleeve or the shaft forming the bearing clearance therebetween in which fluid pressure is relatively low, for example, in the reservoir part 231. Since the auxiliary groove 233 may serve to assist in pumping the fluid, it is not preferable that the pumping force is excessively increased. Therefore, fluid pressure may be formed to be relatively low to thereby allow the pumping force not to be increased to a predetermined level or more.

The rotor hub 250 may be coupled to the sleeve 240 to thereby rotate together with the sleeve 240.

The rotor hub 250 may include a rotor hub body 252 provided with an insertion part 252a in which the sleeve 240 is insertedly disposed, a mounting part 254 extended from an edge of the rotor hub body 252 and including a magnet assembly 280 mounted on an inner surface thereof, and an extension part 256 extended from an edge of the mounting part 254 in the outer radial direction.

Meanwhile, an inner surface of the rotor hub body 252 may be bonded to an outer surface of the sleeve 240. That is, the inner surface of the rotor hub body 252 may be bonded to a bonding surface of the sleeve 240 by an adhesive and/or welding. In addition, the rotor hub body 252 may also be coupled to the sleeve 240 by press-fitting.

Therefore, the sleeve 240 may rotate together with the rotor hub 250 at the time of rotation of the rotor hub 250.

In addition, the mounting part 254 may be extended downwardly from the rotor hub body 252 in the axial direction. Further, the mounting part 254 may include the magnet assembly 280 fixedly installed on the inner surface thereof.

Meanwhile, the magnet assembly 280 may include a yoke 282 fixedly installed on the inner surface of the mounting part 254 and a magnet 284 installed on an inner peripheral surface of the yoke 282.

The yoke 282 may serve to direct a magnetic field from the magnet 284 toward the stator core 202 to thereby increase magnetic flux density. Meanwhile, the yoke 282 may have a circular ring shape. One end portion of the yoke 282 may be bent so as to increase the magnetic flux density by the magnetic field generated from the magnet 284.

The magnet 284 may have an annular ring shape and be a permanent magnet generating a magnetic field having a predetermined strength by alternately magnetizing an N pole and an S pole in the circumferential direction.

Meanwhile, the magnet 284 may be disposed to face a front end of the stator core 202 having a coil 201 wound therearound and generate driving force for rotating the rotor hub 250 by electromagnetic interaction with the stator core 202 having the coil 201 wound therearound.

That is, when power is supplied to the coil 201, the driving force for rotating the rotor hub 250 is generated by the electromagnetic interaction between the stator core 202 having the coil 201 wound therearound and the magnet 284 disposed to face the stator core 202, such that the rotor hub 250 may rotate together with the sleeve 240.

The upper thrust member 260 may be fixedly installed on an upper end portion of the shaft 230 and form an upper liquid-vapor interface F3 together with the upper groove part sidewall of the sleeve 240. The upper thrust member 260 may have an inner surface 262 bonded to the shaft 230 and an outer surface 264 provided in the outer radial direction of the upper thrust member 260 to form the liquid-vapor interface together with the upper groove part sidewall. Here, the outer surface 264 may be provided to form an upper inclined part 261 having a smaller outer diameter in an upper portion than in a lower portion.

Meanwhile, a thrust dynamic pressure groove for generating thrust dynamic pressure may be formed in at least one of a lower surface of the upper thrust member 260 and the upper groove part bottom of the sleeve 240 disposed to face the lower surface of the upper thrust member 260. According to the embodiment of the present invention, in the case in which the circulation hole 247 is formed in the sleeve 240, the thrust dynamic pressure groove may be formed in the inner radial direction with respect to the circulation hole 247.

In addition, an upper cap 291 may be provided on an upper portion of the upper thrust member 260 as a sealing member so as to prevent the lubricating fluid filling the bearing clearance B from being leaked upwardly. The upper cap 291 may cover the upper groove part to prevent the lubricating fluid from being scattered and leaked through the upper groove part. That is, the upper cap 291 maybe fixed to the upper groove part sidewall of the sleeve 240 by press-fitting or using an adhesive, and a clearance between the shaft 230 and a shaft hole of the upper cap 291 allowing the shaft 230 to be protruded upwardly of the upper cap 291 is sufficiently narrow to suppress air containing the evaporated lubricating fluid from being leaked to the outside, whereby a reduction of the lubricating fluid filling the bearing clearance B may be suppressed.

The lower thrust member 220 may be fixedly installed on a lower end portion of the shaft 230 and form a lower liquid-vapor interface F4 together with the lower groove part sidewall of the sleeve 240. The lower thrust member 220 may have an inner surface 222 bonded to the shaft 230 and an outer surface 224 provided in the outer radial direction of the lower thrust member 220 to form the liquid-vapor interface together with the lower groove part sidewall. Here, the outer surface 224 may be provided to form a lower inclined part 221 having a smaller outer diameter in a lower portion than in an upper portion.

Meanwhile, a thrust dynamic pressure groove for generating thrust dynamic pressure may be formed in at least one of an upper surface of the lower thrust member 220 and the lower groove part bottom of the sleeve 240 disposed to face the upper surface of the lower thrust member 220. According to the embodiment of the present invention, in the case in which the circulation hole 247 is formed in the sleeve 240, the thrust dynamic pressure groove may be formed in the inner radial direction with respect to the circulation hole 247.

In addition, a lower cap 293 may be provided on a lower portion of the lower thrust member 220 as a sealing member so as to prevent the lubricating fluid filling the bearing clearance B from being leaked downwardly. The lower cap 293 may cover the lower groove part to prevent the lubricating fluid from being scattered and leaked through the lower groove part. That is, the lower cap 293 may be fixed to the lower groove part sidewall of the sleeve 240 by press-fitting or using an adhesive, and a clearance between the shaft 230 and a shaft hole of the lower cap 293 allowing the shaft 230 to be protruded upwardly of the lower cap 293 is sufficiently narrow to suppress air containing the evaporated lubricating fluid from being leaked to the outside, whereby a reduction of the lubricating fluid filling the bearing clearance B may be suppressed.

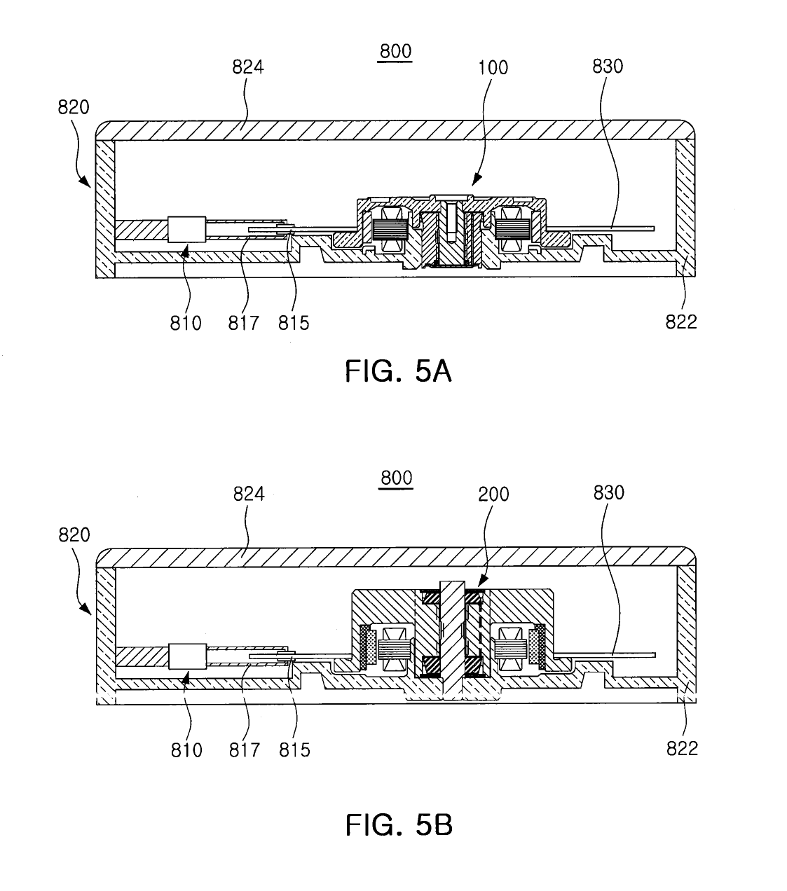

Referring to FIGS. 5A and 5B, a recording disk driving device 800 may be a hard disk driving device having the motor 100 or 200 according to the embodiment of the present invention mounted therein, and may include the motor 100 or 200, a head transfer part 810, and a housing 820.

The motor 100 or 200 has all the characteristics of the motor according to the embodiments of the present invention and may have a recording disk 830 mounted thereon.

The head transfer part 810 may transfer a head 815 able to detect information stored on the recording disk 830 mounted on the motor 100 or 200 to a surface of the recording disk from which the information is to be detected.

Here, the head 815 may be disposed on a support part 817 of the head transfer part 810.

The housing 820 may include a motor mounting plate 822 and a top cover 824 covering an upper portion of the motor mounting plate 822 in order to form an internal space receiving the motor 100 or 200 and the head transfer part 810.

As set forth above, according to embodiments of the present invention, a bearing span of a spindle motor is sufficiently secured, whereby rotational performance of the spindle motor may be improved.

Further, a simple dynamic pressure groove is added to the spindle motor, whereby performance of the spindle motor may be significantly improved.

While the present invention has been shown and described in connection with the embodiments, it will be apparent to those skilled in the art that modifications and variations can be made without departing from the spirit and scope of the invention as defined by the appended claims.

What is claimed is:

1. A hydrodynamic bearing assembly comprising:
a fixed member;
a rotating member forming, together with the fixed member, a bearing clearance filled with a lubricating fluid and rotating relatively with respect to the fixed member;
upper and lower radial dynamic pressure grooves formed in at least one of the fixed member and the rotating member forming the bearing clearance therebetween while facing each other in order to generate hydrodynamic pressure at the time of rotation of the rotating member; and
an auxiliary groove formed in at least one of the fixed member and the rotating member between the upper and lower radial dynamic pressure grooves in order to pump the lubricating fluid upwardly or downwardly.

2. The hydrodynamic bearing assembly of claim 1, wherein the auxiliary groove has a spiral shape or a helical shape.

3. The hydrodynamic bearing assembly of claim 1, wherein the auxiliary groove is provided to pump the lubricating fluid in a direction of resultant hydrodynamic pressure force generated by the upper and lower radial dynamic pressure grooves through the rotation of the rotating member.

4. The hydrodynamic bearing assembly of claim 1, wherein the upper and lower radial dynamic pressure grooves include a groove shaped reservoir part formed in at least one of the fixed member and the rotating member so that the bearing clearance between the fixed member and the rotating member is wider in the reservoir part as compared to other portions thereof, and
the auxiliary groove is formed in the reservoir part.

5. The hydrodynamic bearing assembly of claim 1, wherein the upper and lower radial dynamic pressure grooves include a groove shaped reservoir part formed in at least one of the fixed member and the rotating member so that the bearing clearance between the fixed member and the rotating member is wider in the reservoir part as compared to other portions thereof, and
the auxiliary groove is formed in a counter member facing the reservoir part.

6. The hydrodynamic bearing assembly of claim 1, wherein the auxiliary groove is formed in a portion of the fixed member and the rotating member forming the bearing clearance therebetween in which fluid pressure is relatively low.

7. The hydrodynamic bearing assembly of claim 1, wherein the auxiliary groove is formed in a circumferential direction.

8. A hydrodynamic bearing assembly comprising:
a shaft;
a sleeve having the shaft rotatably inserted thereinto and forming, together with the shaft, a bearing clearance filled with a lubricating fluid;
upper and lower radial dynamic pressure grooves formed in at least one of the sleeve and the shaft forming the bearing clearance therebetween while facing each other in order to generate hydrodynamic pressure at the time of rotational driving of the shaft; and
an auxiliary groove formed in at least one of the sleeve and the shaft between the upper and lower radial dynamic pressure grooves in order to pump the lubricating fluid upwardly or downwardly.

9. A hydrodynamic bearing assembly comprising:
a shaft fixedly installed directly or indirectly on a base member;
a sleeve rotatably installed on the shaft and forming, together with the shaft, a bearing clearance filled with a lubricating fluid;
upper and lower radial dynamic pressure grooves formed in at least one of the sleeve and the shaft forming the bearing clearance therebetween while facing each other in order to generate hydrodynamic pressure at the time of rotational driving of the sleeve; and
an auxiliary groove formed in at least one of the sleeve and the shaft between the upper and lower radial dynamic pressure grooves in order to pump the lubricating fluid upwardly or downwardly.

10. A spindle motor comprising:
a hydrodynamic bearing assembly including a fixed member, a rotating member forming, together with the fixed member, a bearing clearance filled with a lubricating fluid and rotating relatively with respect to the fixed member, upper and lower radial dynamic pressure grooves formed in at least one of the fixed member and the rotating member forming the bearing clearance therebetween while facing each other in order to generate hydrodynamic pressure at the time of rotation of the rotating member, and an auxiliary groove formed in at least one of the fixed member and the rotating member between the upper and lower radial dynamic pressure grooves in order to pump the lubricating fluid upwardly or downwardly;
a stator coupled to the fixed member outwardly of the fixed member or the rotating member and including a core having a coil wound therearound in order to generate rotational driving force; and
a hub fixed to the rotating member so as to be rotatable with respect to the stator and having a magnet mounted on one surface thereof, the magnet facing the coil.
